(19) United States
(12) Patent Application Publication
(10) Pub. No.: US 2011/0119772 A1
(43) Pub. Date: May 19, 2011

(54) Media Content Transfer and Remote License Acquisition

(76) Inventors: Gregory Lipinski, Loveland, CO (US); William Girard McCollom, Fort Collins, CO (US)

(21) Appl. No.: 13/003,865

(22) PCT Filed: Jul. 21, 2008
(86) PCT No.: PCT/US08/70615

§ 371 Date: Jan. 12, 2011

(51) Int. Cl. G06F 21/24

(52) U.S. Cl. 726/29; 726/27

(57) ABSTRACT

In one embodiment of a method of providing protected data from a network server, a data file is downloaded from an external source to a computer on a network. The downloaded file is stored in a location accessible to a server on the network. Using a computer on the network connected to the server, a license linked to the server for the data is procured from an external source. The data file is played from the server using the license.

### BACKGROUND

Data files, including, for example, music and other sound recordings, are commercially available to the public over the Internet. Many such files are supplied subject to licenses that restrict the use that the recipient may lawfully make of the file. In some cases, a Digital Rights Management (DRM) system is used that mechanically restricts the use made of the file. For example, some media files can be played back only using a specialized media player program, and the media player is programmed to play back the media file only if the media player is also provided with an electronic license. In order to prevent the indiscriminate copying of the data file together with its accompanying license, these licenses are customized to the specific computer on which the media file is to be played. Therefore, the license must be generated directly in a transaction between the correct computer and an external license-issuing authority.

Obtaining a license is usually an interactive process, for example, it may require the user to enter payment or other personal details, and existing systems assume the user is operating the computer on which the content is to be licensed. Licensing takes place either when the media file is downloaded, or when the user first tries to play the media file and the media player raises a DRM error because the proper license is not present.

File servers are now available for small networks, even for networks in private homes, that run without a console. The homeowner may reasonably wish to stream media playback from such a “home server” to other devices on the network, which may include specialist media display devices that do not have a computer console.

The server is typically operated as an “always on” device, that is always available on the network, whereas individual personal computers are frequently switched off when not in use, and in the case of a portable computer may be removed from the network. Streaming media content from the server, instead of from a personal computer attached to the network, enables the media to be played at any time, without relying on a specific personal computer being attached to the network.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram of an embodiment of a computer system.

FIG. 2 is a flowchart of an embodiment of a process to acquire and play media.

FIG. 3 is a diagram of another embodiment of a computer system.

FIG. 4 is a flowchart of another embodiment of a process to acquire and play media.

### DETAILED DESCRIPTION

The following description is provided to enable any person skilled in the art to which the invention pertains to make and use the invention and sets forth the best modes presently contemplated by the inventor for carrying out the invention. Various modifications, however, will remain readily apparent to those skilled in the art, since the basic principles of the present invention have been defined herein. Any and all such modifications, equivalents and alternatives are intended to fall within the spirit and scope of the presently claimed invention.

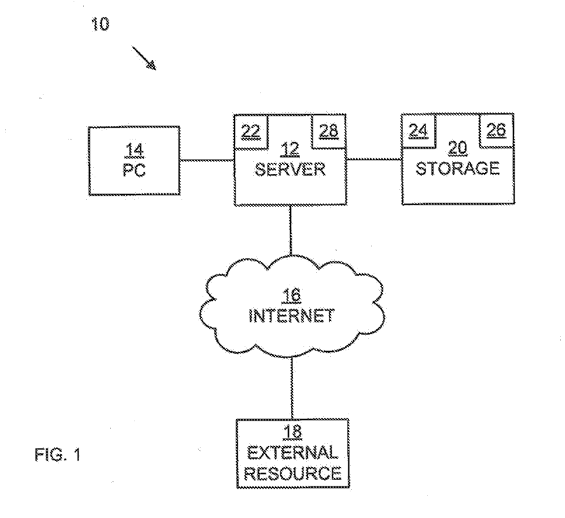

Referring to the accompanying drawings, and initially to FIG. 1, computer system in the form of a home computer network indicated generally by the reference numeral 10 comprises a server 12 and a personal computer 14. The server 12 is also connected through an external network 16, such as the internet, to external resources 18, for example, a supplier of network-accessible (e.g. downloadable) media content. Examples of such media content can be musical works, sound recordings, digital audio (including, but not limited to, timeline-synchronized audio, music, voice, and sounds), video, animation, graphics, photographs, album artwork, artists' names, likenesses, biographical material, digital video, etc.

The server 12 shown in FIG. 1 has access to data storage 20, which may be physically included in or attached to the server 12, or may be a separate device. The data storage 20 is also accessible to the personal computer 14, either directly or through the server 12. The server 12 is provided with a media server program 22 that is capable of playing media files, containing media content, 24 from the data storage 20, using for media files with Digital Rights Management (DRM) protection a license 26 linked to the server 12 and stored in the data storage 20.

The server 12 is also provided with a Direct License Acquisition (DLA) agent 28, which may be part of the media server program 22 or may be a separate piece of software, and is controlled from the personal computer 14.

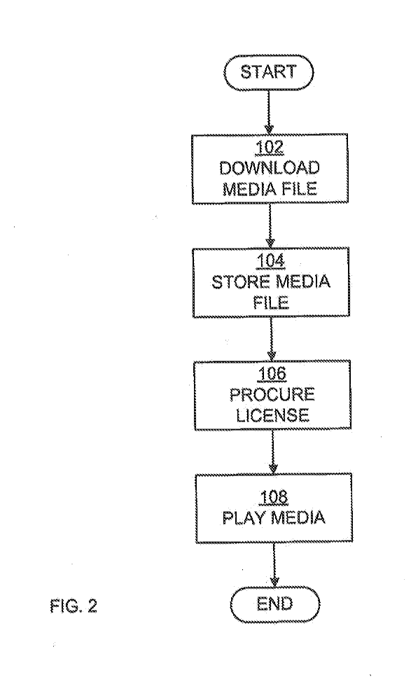

Referring now also to FIG. 2, in one embodiment of a method, in step 102 a user (not shown) operating the personal computer 14 downloads a media file 24 from the external media supplier 18.

In step 104 the user stores the downloaded file 24 in the data storage 20, where the file is accessible to the server 12. Steps 102 and 104 may form part of a single operation, or the file 24 may be temporarily downloaded to the personal computer 14 and then copied or moved to the storage 20. Procedures and software for downloading of files from internet web sites using a web browser on the user's computer are known, and any of these procedures can be used.

In step 106, the user uses the computer 14 connected to the server 12, which communicates with the DLA agent 28 on the server 12, to procure from the media supplier 18 a license 26 linked to the server 12 for the media file, containing media content, 24 and store the license 26 in the data storage 20.

In step 108, the user plays the media file 24 using the media server program 22. The media server program 22 accesses the saved media file 24 and the license 26, then verifies that the media file 24 is properly licensed, reads the media file, and streams the media content to the user.

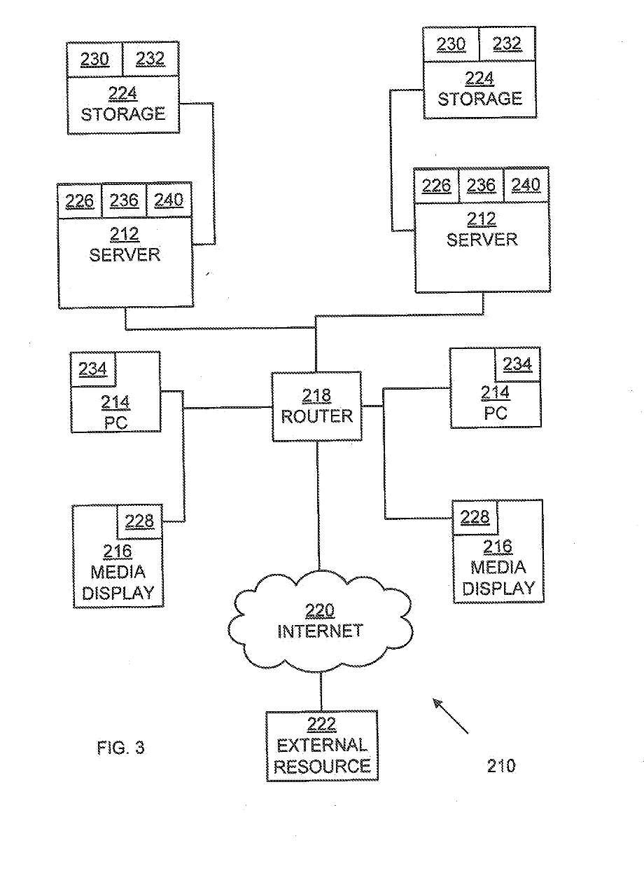

Referring now to FIG. 3, a second embodiment of a computer system in the form of a home computer network indicated generally by the reference numeral 210 comprises one or more home servers 212, one or more personal computers 214, and one or more media displays 216 networked together through one or more routers 218. The media displays 216 shown in FIG. 3 are audiovisual display devices for visual, audiovisual, or audio media. Alternatively, the media displays 216 may be sound reproducing devices for audio media, or some other form of suitable device. The home network 210 is also connected through an external network 220, such as the internet, to one or more external resources 222, such as media suppliers. The server 212 shown in FIG. 3 may not have a console or other user interface, but can be controlled indirectly over the home network 210.

The server 212 shown in FIG. 3 has access to data storage 224, which may be physically included in or attached to the server 212, or may be elsewhere on the home network 210. The data storage 224 is also accessible to at least one personal computer 214 on the home network 210, either directly or through the server 212. In an embodiment, the network data storage 224 is configured so as to appear as a virtual drive on the personal computer 214, for example, through a protocol such as Server Message Block (SMB) or Common Internet File System (CIFS).

The server 212 is provided with a media server program 226 that is capable of playing media files 230 from the data storage 224, using for media files with Digital Rights Management (DRM) protection a license 232 customized to the server 212 and stored in the data storage 224, and streaming the media content to a client media receiver program 228 on another device on the network, for example, a media display device 216, where the content stream is converted into actual sound, images, or other user-perceptible form. Media server and receiver programs that cooperate in this way are commercially available and, in the interests of conciseness, the programs 226 and 228 are not described in detail.

The home server 212 is also provided with a DLA agent 236, which may be part of the media server program 226, or may be a separate program. The DLA agent 236 can be controlled remotely by a utility program 234 on one of the personal computers 214. Especially if the DLA agent 236 is part of the media server program 226, the home server 212 may also be provided with an interface utility program 240 to interface the DLA agent 236 to the utility program 234.

The media display device 216 has sufficient user controls to enable a user to select a media file available to the media server program 226, and to command the media server program 226 to play the selected file and stream the media content to the receiver program 228 on the media display device 216. However, the media player 216 is not equipped to exercise any more general control over the server 212.

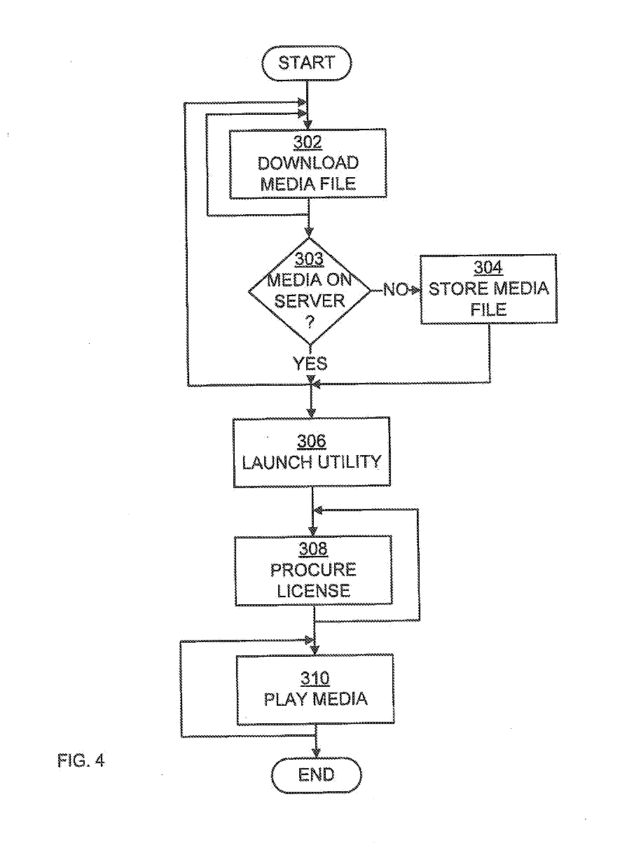

Referring now also to FIG. 4, in one embodiment of a method, in step 302 a user (not shown) operating a personal computer 214 on the home network 210 downloads a media file 230 from the external media supplier 222 to the home network 210. For example, the user may use an internet web browser on the personal computer 214 to connect to a web page on a server of the external media supplier 222, and use the standard download functionality of the web browser to download a media file to a local disk drive on the home network 210. Alternatively, a media manager program (not shown) provided by the external resource 222 may perform the downloading of the media file 230. Procedures and software for downloading of files from internet web sites using a web browser on the user's computer are known, and any of those procedures may be used. The personal computer 214 may be a laptop computer or other portable device that is connected, but optionally not permanently connected, to the network.

As symbolized by decision step 303 in FIG. 4, the media file 230 may be downloaded directly from the external resource 222 to the server storage 224 acting as a virtual drive for the personal computer 214, or may be temporarily downloaded to, for example, the personal computer 214, and then moved or copied (either manually or automatically) to the data storage 224.

If the media file 230 was not downloaded directly from the external resource 222 to the server storage 224, then in step 304 the user moves or copies the downloaded file into the data storage 224, where the file is accessible to the home server 212 on the network 210. The physical location of the data storage 224 may depend on the design of the specific network 210. However, in order for the media content of the file 230 to be continually available, the data storage 224 may be in an “always on” location where it will not be removed from the network if a portable device, such as a personal computer 214 in the form of a laptop computer, is removed, or if a personal computer 214 or other peripheral device is switched off.

Steps 302 and 304 may be repeated to download more than one media file 230 from the same or different external suppliers 222.

In this instance of the embodiment, the file 230 is protected by DRM, and the media server program 226 will not play the file 230 unless the media player is provided with a correct license linked to the home server 212 on which the media server program is running. The media server program 226 is programmed to connect with the external media supplier 222 to procure an appropriate license.

In the interests of simplicity, the external media supplier 222 is shown in FIG. 3 as a unitary entity. However, the supplier of the media file 230 and the issuer of the license 232 may be physically, administratively, and/or legally separate entities.

In step 306, the user uses the utility program 234 from one of the computers 214 on the home network 210 connected to the server 212 to operate the Direct License Acquisition (DLA) agent 236 on the server 212, either directly or through the interface utility program 240. As explained above, the DLA agent 236 may comprise a DLA function of the server media player 226. Alternatively, the DLA agent 236 may be a separate module including a DLA function that can operate independently of the server media player 226. Alternatively, the DLA agent 236 or the interface utility program 240 may be invoked directly from the computer 214, without using a separate utility program 234, or the utility program 234 may invoke directly the DLA agent 236, without using a distinct interface utility program 240. Where both the DLA agent 236 and the interface utility program 240 are present, their functionality may be distributed between them in any appropriate way.

The DLA agent 236 is programmed to connect with the external media supplier 222 to procure an appropriate license in step 308. The license procurement process typically requires at least some user interaction. For example, the user may be required to approve terms of the license, to provide credit card or other payment details, or to provide personal identification information. Even where the user already has an account with the external media supplier 222, at least a username and password are typically requested. The procurement process is run from the server 212, because the license generated typically includes data identifying the computer from which the procurement process is run, and is typically valid only on that computer.

Steps 306 and 308 may be carried out immediately after steps 302 and 304, from the same computer 214, or may be carried out at a later time, and/or from a different computer 214, and/or by a different person.

In an embodiment, the utility program 234 is specific to the licensing operation and presents itself to the user as if it were an ordinary application program running on the personal computer 214. The utility program 234 can then be used by a user not sufficiently technically sophisticated to set up and use a remote desktop interface to control the home server 212 generally.

In step 308, the user uses the utility program 234 with the media server program 226 and/or the DLA agent 236 to procure a license 232 for the media file 230. The interface utility program 240 or the utility program 234 intercepts output to a user interface from the DLA agent 236, or the DLA agent 236 directs output to the utility program 234, and the utility program 234 presents that output on the user interface of the personal computer 214. The utility program 234 receives user input and presents the input (through the interface utility program 240 if applicable) to the DLA agent 236. Where the DLA agent 236 is part of the media server program 226, the input may be presented as if it were input from a user interface on the home server 212.

Step 308 may be repeated to procure licenses 232 for more than one media file 230 on the same server 212.

In step 310, the user plays the media file 230 by remote command from one of the other devices 214, 216 on the network. The media server program 236 accesses the saved media file 230 and the license 232, verifies that the media file 230 is properly licensed, reads the media file 230, and streams the content of the media file 230 to the commanding device 214 or 216. At the commanding device, the client media receiver program 228 receives the content stream and produces actual sound or images for the users benefit. Step 310 may take place immediately after step 308, and from the same personal computer 214. However, step 310 can take place at a later time, and/or from a different commanding device, including a media display or other transducer device 316 that would not be able to run the utility program 234.

Typically, step 310 may be repeated a number of times. Commonly available licenses 232 may permit a specified number of playings of the media file 230, or may permit unlimited numbers of playings over a definite or indefinite period.

Various modifications and variations can be made in the present invention without departing from the spirit or scope of the invention. Thus, it is intended that the present invention cover the modifications and variations of this invention provided they come within the scope of the appended claims and their equivalents.

For example, although the specific embodiments shown in the drawings refer to downloading and playing a media file, which may be, for example, a sound recording or video, embodiments include other files protected by similar DRM systems, including other forms of data, including computer readable instructions (programs), and playing or using such a file may then be interpreted as is appropriate for the content of the specific file.

What is claimed is:

1. A method of providing protected data from a network server, comprising:
downloading a data file from an external source to a computer on a network;
storing the downloaded file in a location accessible to a server on the network;
procuring from an external source a license linked to the server for the data by using a computer on the network connected to the server; and
accessing data in the data file from the server using the license.

2. The method according to claim 1, wherein the downloading of the data file and the procuring of the license are carried out from the same computer on the network in a single transaction.

3. The method according to claim 1 or claim 2, wherein the accessing of data in the data file comprises streaming the data from the server to another device on the network.

4. The method according to claim 3, wherein procuring the license and playing the data file do not occur in a single session using a single computer as said computer on the network and said device on the network.

5. The method according to claim 4, wherein when the data file is played for the first time after procuring said license, said device on the network is not capable of acting as said computer on the network.

6. The method according to any of claims 1 to 5, wherein said data file is a media file, and accessing data in the data file comprises streaming media data to a device on the network that converts the data into a form perceptible to a user.

7. Computer readable storage media containing instructions to cause a program on a first computer to communicate with an external source to procure a license linked to the first computer to authorize a program on the first computer to use a data file accessible to said program on the first computer, said instructions including instructions to cause user interactions required for procuring said license to take place entirely at a user interface of a second computer in communication with the first computer.

8. Storage media according to claim 7, wherein said instructions include instructions to cause user interactions required for procuring said license to take place entirely at said user interface of said second computer without giving a user of said second computer full control of said first computer.

9. Storage media according to claim 7 or claim 8, wherein said instructions are instructions to said first computer, including instructions to said first computer to send output to said second computer and to respond to input from said second computer.

10. Storage media according to any of claims 7 to 9, wherein said instructions include instructions to operate on said first computer a player program including a Direct License Acquisition function.

11. A first computer having a user interface and comprising computer readable storage media containing instructions to cause the first computer to cause a program on a second computer in communication with the first computer to communicate with an external source to procure a license linked to the second computer, in order to authorize said program on the second computer to use a data file accessible to said program on the second computer, said instructions including instructions to cause user interactions required for procuring said license to take place entirely at said user interface of said first computer.

12. The computer of claim 11, wherein said instructions are to cause user interactions required for procuring said license to take place at said user interface of said first computer without enabling user interactions in respect of functions of said second computer unrelated to procuring said license.

13. A computer network comprising:
a first computer in communication with resources external to said network;
a second computer having a user interface in communication with said first computer;
computer readable storage media containing instructions to cause said first computer to use a data file only when a license corresponding to said data file and linked to said first computer is present, and containing instructions to cause said first computer to procure a license from said external resources when said data file is present and said license is not present, and to cause user interactions required for procuring said license to take place at said user interface of said second computer.
